(19) United States
(12) Patent Application Publication
(10) Pub. No.: US 2016/0197406 A1
(43) Pub. Date: Jul. 7, 2016

(54) DUAL-POLARIZED ANTENNA

(71) Applicant: KABUSHIKI KAISHA TOSHIBA, Tokyo (JP)

(72) Inventors: Koh HASHIMOTO, Yokohama Kanagawa (JP); Makoto HIGAKI, Setagaya Tokyo (JP); Manabu MUKAI, Yokohama Kanagawa (JP)

(73) Assignee: KABUSHIKI KAISHA TOSHIBA, Tokyo (JP)

(21) Appl. No.: 14/924,559

(22) Filed: Oct. 27, 2015

(30) Foreign Application Priority Data
Jan. 6, 2015 (JP) 2015-000864

(51) Int. Cl. H01Q 9/04; H01Q 1/48

(52) U.S. Cl. CPC H01Q 9/045; H01Q 1/48

(57) ABSTRACT

A dual-polarized antenna includes a first ground conductor; and a metal patch conductive to the first ground conductor. The metal patch has a radiation surface which is uncovered by the first ground conductor. The antenna further includes a first feed probe coupled to the metal patch; a second ground conductor disposed in an opposite side to the first surface with reference to the first ground conductor. The second ground conductor has at least one of the empty space and the non-empty space of insulator. The antenna further includes a second feed probe spatially separated by the at least one space from the first feed probe. The second feed probe is coupled to the metal patch through the at least one space.

### CROSS-REFERENCE TO RELATED APPLICATIONS

This application is based upon and claims the benefit of priority from Japanese Patent Application No. 2015-000864, filed Jan. 6, 2015, the entire contents of which are incorporated herein by reference.

### FIELD

Embodiments described herein relate generally to a dual-polarized antenna.

### BACKGROUND

In the related art, there is a dual-polarized antenna which radiates two orthogonal polarization waves at different frequencies. In this dual-polarized antenna, the aspect ratio in the shape of the radiation element changes in accordance with a reverse ratio of a frequency ratio of two polarized waves. However, when the difference in frequency of the two polarized waves increase, an aspect ratio, for example, a ratio of a long side to a short side, of the radiation element increases, causing a failure such as decreased arrangement efficiency of the radiation element and also causing that the radiation element with the increased aspect ratio can have undesired coupling with a feed circuit.

### BRIEF DESCRIPTION OF THE DRAWINGS

FIG. 1 is a diagrammatic perspective view which schematically illustrates a configuration of a dual-polarized antenna according to an embodiment;

FIG. 2 is a diagrammatic perspective view which schematically illustrates a configuration of the dual-polarized antenna according to a first variation of the embodiment;

FIG. 3 is a diagrammatic perspective view which schematically illustrates the configuration of the dual-polarized antenna according to a second variation of the embodiment;

FIG. 4 is a diagrammatic perspective view which schematically illustrates the configuration of the dual-polarized antenna according to a third variation of the embodiment;

FIG. 5 is a diagrammatic perspective view which schematically illustrates the configuration of the dual-polarized antenna according to a fourth variation of the embodiment;

FIG. 6 is a diagrammatic perspective view which schematically illustrates the configuration of the dual-polarized antenna according to a fifth variation of the embodiment;

FIG. 7 is a diagrammatic perspective view which schematically illustrates the configuration of the dual-polarized antenna according to a sixth variation of the embodiment; and

FIG. 8 is a diagrammatic perspective view which schematically illustrates the configuration of the dual-polarized antenna according to a seventh variation of the embodiment.

### DETAILED DESCRIPTION

In some embodiments, a dual-polarized antenna may include, but is not limited to, a first ground conductor having an opening; a metal patch as a radiation element positioned equal to or lower in level in a lamination direction than the first ground conductor, the metal patch being positioned in the opening of the first ground conductor in view of a direction vertical to the surface of the first ground conductor; a first feed probe positioned under the first ground conductor in the lamination direction, the first feed probe that excites the metal patch; a second ground conductor positioned below the first feed probe in the lamination direction, the second ground conductor having a slot which is generally parallel to the first feed probe, the slot being positioned under the metal patch in the lamination direction; and a second feed probe disposed under the second ground conductor in the lamination direction, the second feed probe being generally perpendicular to the slot. The metal patch has an aspect ratio which is smaller than a frequency ratio of a first frequency to a second frequency where the second frequency is lower than the first frequency, the first frequency is of a first polarized wave that the metal patch transmits and receives upon power feed from the first feed probe, and the second frequency is of a second polarized wave that the metal patch transmits and receives upon power feed from the first feed probe through the slot.

In some cases, the antenna may further include, but is not limited to, a third ground conductor positioned below the second feed probe in the lamination direction.

In some cases, the first feed probe and the second feed probe are positioned under the center of the metal patch in the lamination direction. The slots has the center which is positioned under the center of the metal patch in the lamination direction.

In some cases, the antenna may further include, but is not limited to, at least one metal post disposed at the periphery of the opening.

In some cases, the opening has a shape of rectangle. The at least one metal post may include a plurality of metal posts which includes four pairs of metal posts, each pair of which is disposed along a respective one of the four sides of the periphery of the opening.

In some cases, the antenna may further include a stub extending from the second feed probe.

In some cases, the antenna may further include a stub extending from the first feed probe.

In some cases, the antenna may further include a plurality of sets each comprising the opening, the metal patch, the first feed probe, the slot, and the second feed probe, a first feed circuit which connect the plurality of first feed probes; and a second feed circuit which connect the plurality of second feed probes.

In some cases, the number of the plurality of sets is given by 2^{N}×2^{N}, where N is the arbitrary natural number.

In other embodiments, a dual-polarized antenna may include, but is not limited to, a first ground conductor; a metal patch; a first feed probe coupled to the metal patch; a second ground conductor disposed in an opposite side to the metal patch with reference to the first feed probe, the second ground conductor having at least one of an empty space and a non-empty space of insulator; and a second feed probe spatially separated by at least one of the empty space and the non-empty space of insulator from the first feed probe, the second feed probe being coupled to the metal patch through at least one of the empty space and the non-empty space of insulator.

In some cases, for example, the empty space may typically be a slot which is a narrow hole without any filler. The non-empty space of insulator may typically be a slot which is filled with any available insulating material which is less in conductivity than the first ground conductor.

In some cases, the first feed probe is configured to be electromagnetically coupled to the metal patch.

In some cases, the second feed probe is configured to be electromagnetically coupled through at least one of the empty space and the non-empty space of insulator to the metal patch.

In some cases, the first feed probe is back-coupled to the metal patch.

In some cases, the first ground conductor has at least one opening which is larger in size than the metal patch.

In some cases, the first ground conductor has at least one opening which is larger in size than the metal patch, and the metal patch is positioned in the at least one opening, and the metal patch is substantially the same in level as the first ground conductor.

In some cases, the empty space is a slot which is generally parallel in longitudinal direction to the first feed probe.

In some cases, the metal patch and at least one of the empty space and the non-empty space of insulator overlap each other at least in part from a view vertical to the surface of at least one of the first and second ground conductors.

In some cases, the first and second feed probes cross each other in an overlap area in which the metal patch and at least one of the empty space and the non-empty space of insulator overlap from a view vertical to the surface of at least one of the first and second ground conductors.

In some cases, the metal patch and at least one of the empty space and the non-empty space of insulator overlap each other at least in part from a view vertical to the surface of at least one of the first and second ground conductors, and the first and second feed probes cross each other in an overlap area in which the metal patch and at least one of the empty space and the non-empty space of insulator overlap from the view.

In some cases, at least one of the empty space and the non-empty space of insulator has a dimension which allows an impedance matching between the metal patch and the second feed probe at a frequency lower than a resonant frequency of the metal patch.

In some cases, the empty space is a slot.

In some cases, each of the first and second feed probes cross each other at the center of the metal patch and at the center of the empty space from a view vertical to the surfaces of the first and second ground conductors.

In some cases, the radiation surface is higher in level than an upper surface of the first ground conductor in a direction from the second ground conductor to the first ground conductor, and the direction is vertical to the surfaces of the first and second ground conductors.

In some cases, the radiation surface is the same in level as an upper surface of the first ground conductor in a direction from the second ground conductor to the first ground conductor, and the direction is vertical to the surfaces of the first and second ground conductors.

In some cases, the radiation surface is lower in level than an upper surface of the first ground conductor in a direction from the second ground conductor to the first ground conductor, and the direction is vertical to the surfaces of the first and second ground conductors.

In some cases, the dual-polarized antenna may include at least one metal patch. The dual-polarized antenna may have any dimension and/or any shapes as long as the dimension of at least one of the empty space and the non-empty space of insulator allows an impedance matching between the metal patch and the second feed probe at a frequency lower than a resonant frequency of the metal patch. In some cases, the at least one metal patch may have a shape with an aspect ratio of 1 such as a square. In other cases, the at least one metal patch may have another shape with an aspect ratio of 1 such as a circle. In still other cases, the at least one metal patch may have other shapes with aspect ratios larger or smaller than 1 such as a rectangle, an oval, polygons, or different complex shapes. In some cases, the metal patch has an aspect ratio which is smaller than a frequency ratio of a first frequency to a second frequency. The first frequency is of a first polarized wave that the metal patch transmits and receives upon power feed from the first feed probe. The second frequency is of a second polarized wave that the metal patch transmits and receives upon power feed from the first feed probe through the slot.

Various embodiments of the dual-polarized antenna will be described hereinafter with reference to the accompanying drawings.

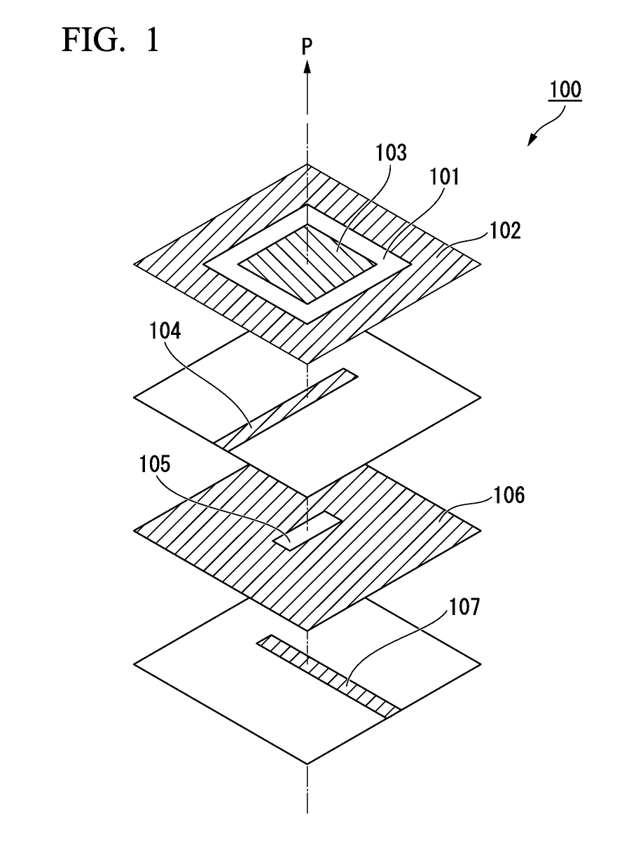

As shown in FIG. 1, a dual-polarized antenna 100 according to an embodiment includes a first ground conductor 102 in which an opening 101 is provided, a metal patch 103, a first feed probe 104, a second ground conductor 106 in which a slot 105 is provided, and a second feed probe 107. For example, the slot 105 may be an empty space or a non-empty space. The empty space may typically be a slot which is a narrow hole without any filler. The non-empty space of insulator may typically be a slot which is filled with any available insulating material which is less in conductivity than the first ground conductor.

The external form of the opening 101 is rectangular. The opening 101 is provided at a central portion of the first ground conductor 102.

The external form of the metal patch 103 is rectangular, for example, square. This causes the aspect ratio, which is the ratio of the dimension of the longitudinal direction to the dimension of the transverse direction of the metal patch 104 to be 1. The metal patch 103 is formed such that the size thereof is smaller than the size of the opening 101. The metal patch 103 is arranged inside the opening 101. In this way, the metal patch 103 and the first ground conductor 102 are arranged at the same height position in the laminated direction P.

The first ground conductor 102 and the metal patch 103 are formed by a conductive material, etc., which is patterned on a surface of an insulator, not shown, such as a dielectric substrate, a resin substrate, a ceramic substrate, formed plastic, a film substrate, etc., for example.

The external form of the first feed probe 104 is rectangular. The first feed probe 104 is arranged below the metal patch 103 and the first ground conductor 102 via the insulator, not shown, in the laminated direction P. A portion of the first feed probe 104 is arranged below a central portion, for example, the center, of the metal patch 103 in the laminated direction P where the laminated direction P is an upward direction, so that the first ground conductor is positioned above the second ground conductor.

The first feed probe 104 excites the metal patch 103 with the resonant frequency of the first frequency by proximity coupled feeding by electromagnetic coupling with the metal patch 103. This causes the metal patch 103 to transmit and receive a first polarized wave of a first frequency which is parallel in the longitudinal direction of the first feed probe 104.

The first feed probe 104 is formed by a conductive material, etc., which is patterned on a surface of an insulator, not shown, such as a resin substrate, a ceramic substrate, formed plastic, a film substrate, etc., for example.

The external form of the slot 105 is rectangular. The second ground conductor 106 in which the slot 105 is provided is arranged below the first feed probe 104 via an insulator, not shown, in the laminated direction P. A central portion, for example, the center, of the slot 105 is arranged below the central portion, for example, the center, of the metal patch 103 in the laminated direction P. The slot 105 is arranged such that the longitudinal direction of the slot 105 is generally parallel to the longitudinal direction of the first feed probe 104. The slot 105 has the dimension in the longitudinal direction set such that it provides impedance matching at a frequency, a below-described second frequency, which is lower than the resonant frequency in accordance with the dimension of the metal patch 103 with respect to feeding to the metal patch 103 by the below-described second feed probe 107.

The second ground conductor 106 are formed by a conductive material, etc., which is patterned on a surface of an insulator, not shown, such as a dielectric substrate, a resin substrate, a ceramic substrate, formed plastic, a film substrate, etc., for example. The external form of the second feed probe 107 is rectangular. The second feed probe 107 is arranged below the second ground conductor 106 via the insulator, not shown, in the lamination direction P. A portion of the second feed probe 107 is arranged below the central portion, for example, the center, of the metal patch 103 in the lamination direction P. The second feed probe 107 is arranged such that the longitudinal direction of the second feed probe 107 is generally orthogonal to the longitudinal direction of the slot 105.

The second feed probe 107 excites the metal patch 103 with the resonant frequency of the second frequency, which is lower than the first frequency by slot coupled feeding by electromagnetic coupling with the metal patch 103 via the slot 105. This causes the metal patch 103 to transmit and receive a second polarized wave of the second frequency which is parallel in the longitudinal direction of the second feed probe 107, or, in other words, the second polarized wave which is generally orthogonal to the first polarized wave.

The second feed probe 107 is formed by a conductive material, etc., which is patterned on a surface of an insulator, not shown, such as a dielectric substrate, a resin substrate, a ceramic substrate, formed plastic, a film substrate, etc., for example.

A dual-polarized antenna 100 according to the above-described embodiment may have the slot 105 which provides impedance matching at a frequency which is lower than the resonant frequency of the metal patch 103 itself to set the aspect ratio of the metal patch 103 to be smaller than the frequency ratio of the first frequency to the second frequency.

For example, for proximity coupled feeding, the metal patch 103 resonates when the dimension in the direction parallel to the direction of the feed probe is approximately one-half wavelength so as to provide impedance matching. In this way, when the first frequency and the second frequency of the first polarized wave and the second polarized wave, which are two orthogonal polarized waves, are set to be different frequencies, the dimension ratio of the rectangular metal patch 103 is equal to the frequency ratio of the first frequency to the second frequency. On the hand, for slot coupled feeding, impedance matching is provided at a frequency lower than the resonant frequency of the metal patch 103 itself in accordance with the dimension of the longitudinal direction of the slot 105. Slot coupled feeding may be used for the second polarized wave having the second frequency which is smaller than the first frequency of the first polarized wave to make the aspect ratio of the metal patch 103 smaller than the frequency ratio of the first frequency to the second frequency.

Moreover, the dual-polarized antenna 100 in the above-described embodiment has a first feeding probe 104 which has the longitudinal direction which is generally parallel to the longitudinal direction of the slot 105 and a second feeding probe 107 which has the longitudinal direction which is generally orthogonal to the longitudinal direction of the slot 105, making it possible to improve cross polarization discrimination.

Furthermore, the dual-polarized antenna 100 in the above-described embodiment has the first feeding probe 104 and the second feeding probe 107 whose mutual longitudinal directions are generally orthogonal, making it possible to improve isolation between the input/output port to which the first feed probe 104 is connected and the input/output port to which the second feed probe 107 is connected.

Moreover, the dual-polarized antenna 100 in the above-described embodiment has the slot 105, and the first feed probe 104 and the second feed probe 107 that are arranged below the central portion of the metal patch 103 in the lamination direction P, making it possible to further improve the cross polarization discrimination and isolation.

Below, variations are described.

While the external form of the metal patch 103 has been described as being rectangular in the above-described embodiment, it is not limited thereto. The external form of the metal patch 103 may be polygonal, circular, or different complex shapes, for example. In one case that the external form of the metal patch 103 is an ellipse, for example, the aspect ratio of the metal patch 103 is a ratio of the major axis to the minor axis of the ellipse, or a ratio of the longer side to the shorter side of a virtual rectangle which circumscribes the ellipse. In another case that the external form of the metal patch 103 is a polygon, for example, the aspect ratio of the metal patch 103 is a ratio of a virtual smallest rectangle circumscribes the polygon. In other words, the aspect ratio of the metal patch 103 which has the external form of various shapes is a ratio of the longer side to the shorter side of a smallest rectangle which circumscribes the external form of the metal patch 103.

While it is described in the above-described embodiment that the first feed probe 104 excites the metal patch 103 by proximate coupling feeding by electromagnetically coupling with the metal patch 103, it is not limited thereto.

The feed probe 104 may excite the metal patch 103 with the resonant frequency of the first frequency by back-coupling feeding by being connected with the metal patch 103 by a metal via.

Below, a first variation is described.

While it is described in the above-embodiment that the metal patch 103 is arranged at the same height location as the first ground conductor 102 in the lamination direction P by being arranged inside the opening 101, it is not limited thereto.

Moreover, while it is described in the above-embodiment that the first feed probe 104 is arranged below the metal patch 103 via an insulator, not shown, in the lamination direction P.

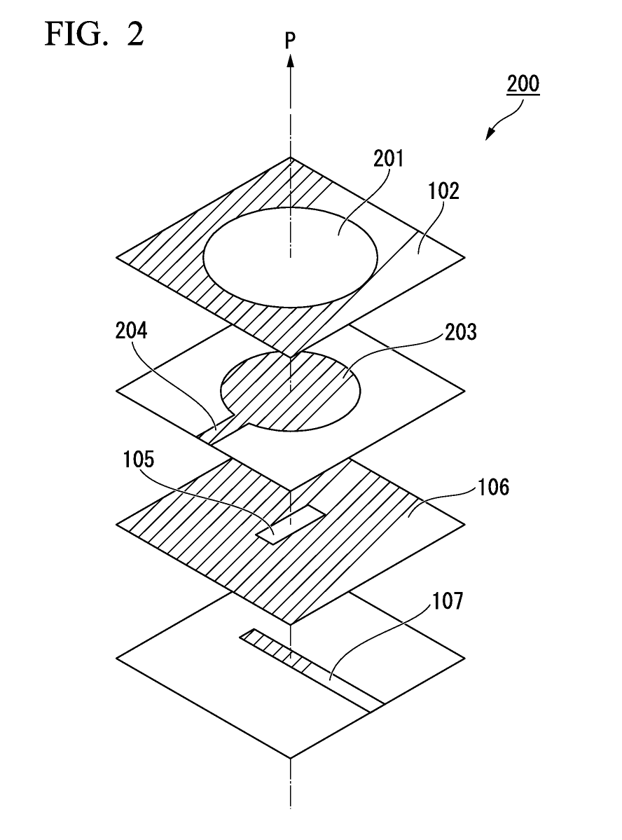

As shown in FIG. 2, a dual-polarized antenna 200 according to the first variation includes the first ground conductor 102 in which an opening 201 is provided, a metal patch 203, a first feed probe 204, the second ground conductor 106 in which the slot 105 is provided, and the second feed probe 107. The dual-polarized antenna 200 according to the first variation is different from the dual-polarized antenna 100 according to the above-described embodiment in that the dual-polarized antenna 200 according to the first variation includes an opening 201, a metal patch 203, and a first feed probe 204.

Below, while omitting or simplifying the explanations for the same parts as the parts in the dual-polarized antenna 100 according to the above-described embodiment, points thereof which are different from those of the above-described dual-polarized antenna 100 are explained.

The external form of the opening 201 is formed in a circle. The opening 201 is provided at the central portion of the first ground conductor 102.

The external form of the metal patch 203 is formed in a circle. This causes the aspect ratio, which is a ratio of the dimension in the longitudinal direction, in other words, the long side, to the dimension in the transverse direction, in other words, the short side, of the metal patch 203 to be 1. The metal patch 203 is formed to have the size thereof which is smaller than the size of the opening 201. The metal patch 203 is arranged below the first ground conductor 102 via the insulator, not shown, in the lamination direction P. The metal patch 203 is provided at a position at which an orthographic projection onto the first ground conductor 102 is provided at a position inside the opening 201.

The external form of the first feed probe 204 is rectangular. The first feed probe 204 is arranged below the first ground conductor 102 via the insulator, not shown, in the lamination direction P. The first feed probe 204 is connected to the metal patch 203. In this way, the metal patch 203 and the first feed probe 204 are arranged at the same height location.

The first feed probe 204 excites the metal patch 203 at the resonant frequency of the first frequency by coplanar feeding by being electrically-connected with the metal patch 203. In this way, the metal patch 203 transmits and receives a first polarized wave of a first frequency which is parallel in the longitudinal direction of the first feed probe 204.

The second ground conductor 106 in which the slot 105 is provided is arranged below the first feed probe 204 via an insulator, not shown, in the lamination direction P. The central portion, for example, the center, of the slot 105 is arranged below a central portion, for example, the center, of the metal patch 203 in the lamination direction P. The slot 105 is arranged such that the longitudinal direction of the slot 105 is arranged generally parallel in the longitudinal direction of the first feed probe 204.

A portion of the second feed probe 107 is arranged below the central portion, for example, the center, of the metal patch 203 in the lamination direction P.

The second feed probe 107 excites the metal patch 203 at the resonant frequency of a second frequency, which is lower than the first frequency by slot coupled feeding by electromagnetic coupling with the metal patch 203 via the slot 105. In this way, the metal patch 203 transmits and receives a second polarized wave, in other words, a second polarized wave which is generally orthogonal to the first polarized wave, of a second frequency which is parallel in the longitudinal direction of the second feed probe 107.

The first variation, having a slot 105 which provides impedance matching at a frequency which is lower than the resonant frequency of the metal patch 203 itself, makes it possible to set the aspect ratio of the metal patch 203 to be smaller than the frequency ratio of the first frequency to the second frequency.

Below, the second variation is described.

While it is described in the above-described embodiment that one each of the opening 101, the metal patch 103, and the slot 105 is included, it is not limited thereto.

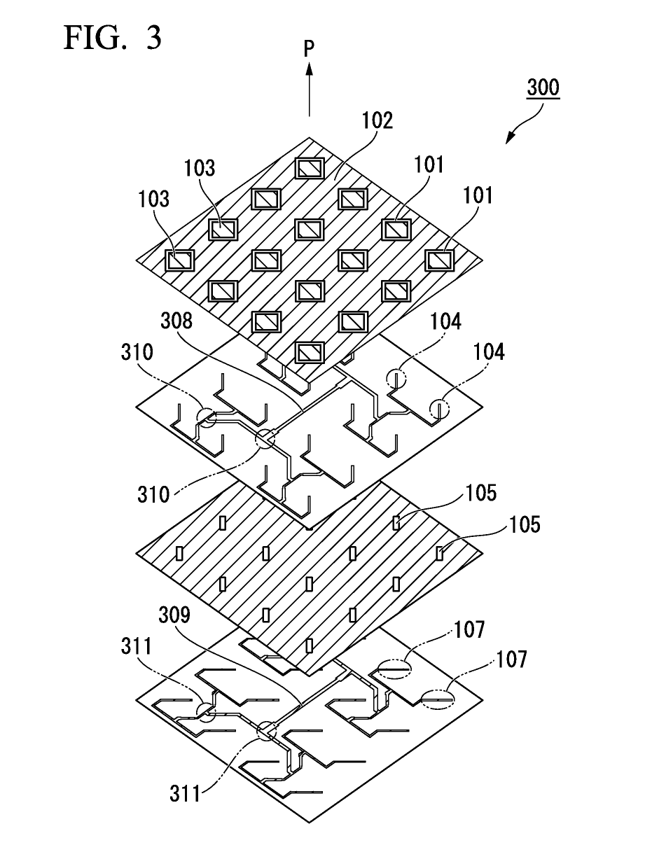

As shown in FIG. 3, a dual-polarized antenna 300 according to the second variation includes the first ground conductor 102 in which multiple openings 101 are provided; multiple metal patches 103; multiple first feed probes 104; the second ground conductor 106 in which multiple slots 105 are provided; multiple second feed probes 107; a first feed circuit 308; and a second feed circuit 309. The dual-polarized antenna 300 according to the second variation is an array antenna in which multiple dual-polarized antennas 100 according to the above-described embodiment are arrayed in a lattice. Each of multiple openings 101, multiple metal patches 103, multiple first feed probes 104, multiple slots 105, and multiple second feed probes 107 is arranged in a lattice.

Below, while omitting or simplifying explanations for the same part as the dual-polarized antenna 100 according to the above-described embodiment, points which are different from the dual-polarized antenna 100 according to the above-described embodiment are explained.

Each of the multiple openings 101, the multiple metal patches 103, and the multiple slots 105 are arranged in a lattice in equal intervals in a direction which is generally 45° tilted relative to the respective polarization directions of the first polarized wave and the second polarized wave. The number of each of the multiple openings 101, the multiple metal patches 103, and the multiple slots 105 is 2^{N}×2^{N} with N as an arbitrary natural number.

The first feed circuit 308 is a parallel-feeding type feed circuit having a symmetrical structure of a so-called complete tournament-type. The first feed circuit 308 includes multiple T-type branches 310 connected in multiple stages. Each of the multiple T-type branches 310 divides input power into two. The multiple first feed probes 104 are connected to multiple ends of the first feed circuit 308.

The second feed circuit 309 is a parallel-feeding type feed circuit having a symmetrical structure of a so-called complete tournament-type. The second feed circuit 309 includes multiple T-type branches 311 connected in multiple stages. Each of the multiple T-type branches 311 divides input power into two. The multiple second feed probes 107 are connected to multiple ends of the second feed circuit 309.

The second variation, having the multiple metal patches 103 with an aspect ratio which is smaller than the frequency ratio of the first polarized wave to the second polarized wave, may improve the arrangement efficiency of the multiple metal patches 103 which are arranged in a lattice, and improve the antenna characteristics for each area. Multiple metal patches 103 are arranged in a lattice in equal intervals, so that an occurrence of unwanted coupling between the first feed circuit 308 and the second feed circuit 309 may be suppressed while having an antenna opening as a square for obtaining the maximum antenna gain relative to the maximum antenna diameter. The multiple metal patches 103 are arranged in a lattice in a direction which is generally tilted by 45° relative to the polarization direction, so that a sidelobe may be reduced while securing an interval for suppressing unwanted coupling with the first feed circuit 308 and the second feed circuit 309.

When the lattice direction of multiple metal patches 103 is tilted relative to the polarization direction, each of the metal patches 103 and the feed circuit are likely to be proximate compared to when the lattice direction is not tilted relative to the polarization direction, resulting in that the undesired coupling is likely to occur, so that the antenna characteristics are likely to degrade. On the other hand, according to the second variation, the metal patches 103 have the reduced aspect ratio. The reduction in aspect ratio of the metal patches 103 will make it possible to suppress substantive degradations of the performances and characteristics of the antenna, even if the lattice direction of the multiple metal patches 103 is tilted relative to the polarization direction and each of the metal patches 103 and the feed circuit are proximate.

Compared to the dual-polarized antenna 100 according to the above-described embodiment, which is one radiation element, the dual-polarized antenna 300, which is set to be an array antenna, may obtain a higher gain and makes it possible to conduct communications farther away.

It has a complete tournament-type first feed circuit 308 and second feed circuit 309, making it possible to simplify the circuit configuration.

While it is described in the above-described second variation that the lattice direction of the multiple metal patches 103 is tilted by a tilt angle of 45°, it is not limited thereto, so that the tilt angle may be an angle different from 45°, or there may be no tilt.

In the above-described second variation, the excitation amplitude and the excitation phase of each of the multiple metal patches 103 may be varied to improve the antenna gain and suppress the sidelobe. The division ratio of each of multiple T-type branches 310 and 311 may be set to be an equal amplitude/equal phase division or non-symmetrical division, etc., to change the excitation amplitude and the excitation phase of each metal patch 103 in a desired manner.

While the above-described second variation is arranged to include the multiple T-type branches 310 and 311 which are connected in a multiple stage, it is not limited thereto, so that a branch circuit which divides the input power into at least three may be included in at least some of the branches in accordance with the number of multiple metal patches 103.

In the above-described second variation, the characteristics of each of the multiple T-type branches 310 and 311 may be set to be an equal amplitude/equal phase division to excite all metal patches 103 in equal amplitude and equal phase such that the antenna gain reaches the highest. The maximum T-type branches 300 and 301, having symmetry, make it possible to realize equal amplitude and equal phase division over a wide bandwidth and improve the wide bandwidth characteristics of the first feed circuit 308 and the second feed circuit 309.

Below, a third variation is described.

In the above-described embodiment, a third ground conductor 412 may be provided below the second feed lobe 107 in the lamination direction P.

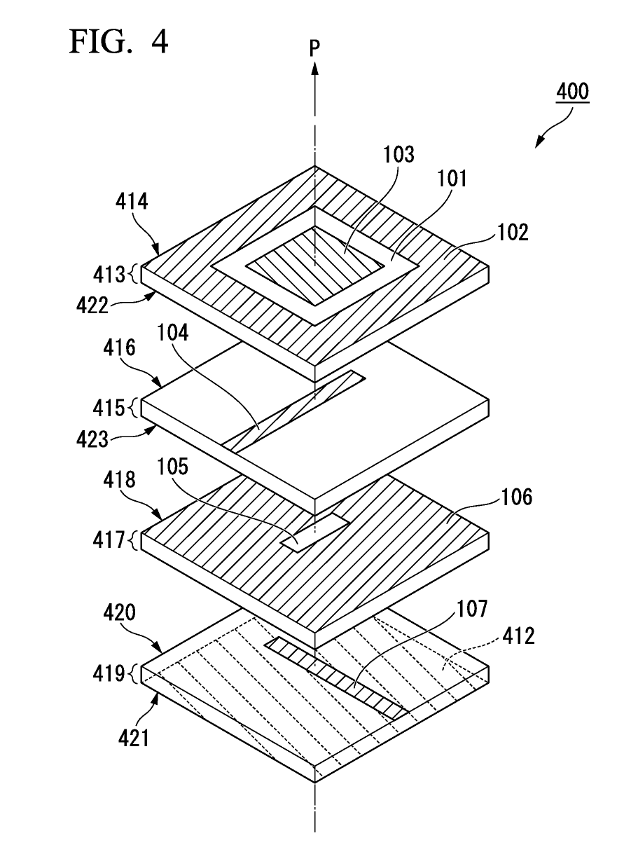

As shown in FIG. 4, a dual-polarized antenna 400 according to a third variation includes the first ground conductor 102 in which the opening 101 is provided, the metal patch 103, the first feed probe 104, the second ground conductor 106 in which the slot 105 is provided, the second feed probe 107, and a third ground conductor 412. The dual-polarized antenna 400 according to the third variation is different from the dual-polarized antenna 100 in that it includes the third ground conductor 412.

Below, while omitting or simplifying explanations for the same portion as the dual-polarized antenna 100, points which are different from the dual-polarized antenna 100 according to the above-described embodiment are explained.

Conductor portions such as the first ground conductor 102 in which the opening 101 is provided, the metal patch 103, the first feed probe 104, the second ground conductor 106 in which the slot 105 is provided, the second feed probe 107, a third ground conductor 412, etc., is formed by a conductive material, etc., which is patterned on a surface of a dielectric substrate.

The first ground conductor 102 and the metal patch 103 is formed on the first main surface 414 of the first dielectric substrate 413. The first feed probe 104 is formed on the first main surface 416 of the second dielectric substrate 415. The second ground conductor 106 is formed on the first main surface 418 of the third dielectric substrate 417. The second feed probe 107 is formed on the first main surface 420 of the fourth dielectric substrate 419. The third ground conductor 412 is formed on the second main surface 421 of the fourth dielectric substrate 419.

The second ground conductor 106 and the third ground conductor 412, and the second feed probe 107, which is arranged between the second ground conductor 106 and the third ground conductor 412, form a stripline, or a triplate line.

The third variation, having the third ground conductor 412 and the second ground conductor 106 sandwiching the second feed probe 107 from both sides of the lamination direction P, may suppress unwanted radiation in the backward direction from the second feed probe 107 to the metal patch 103 and improve the antenna gain.

For example, for directing radio waves in the upward lamination direction P when using a dual-polarized antenna 400 in satellite communications, for example, unwanted radiation in the downward lamination direction P may be suppressed.

According to the above-described third variation, conductor portions such as the first ground conductor 102 in which the opening 101 is provided, the metal patch 103, the first feed probe 104, the second ground conductor 106 in which the slot 105 is provided, the second feed probe 107, a third ground conductor 412, etc., are mutually insulated.

The first feed probe 104 may be formed on a second main surface 422 of the first dielectric substrate 413. The second ground conductor 106 may be formed on a second main surface 423 of the second dielectric substrate 415, for example.

Below, a fourth variation is described.

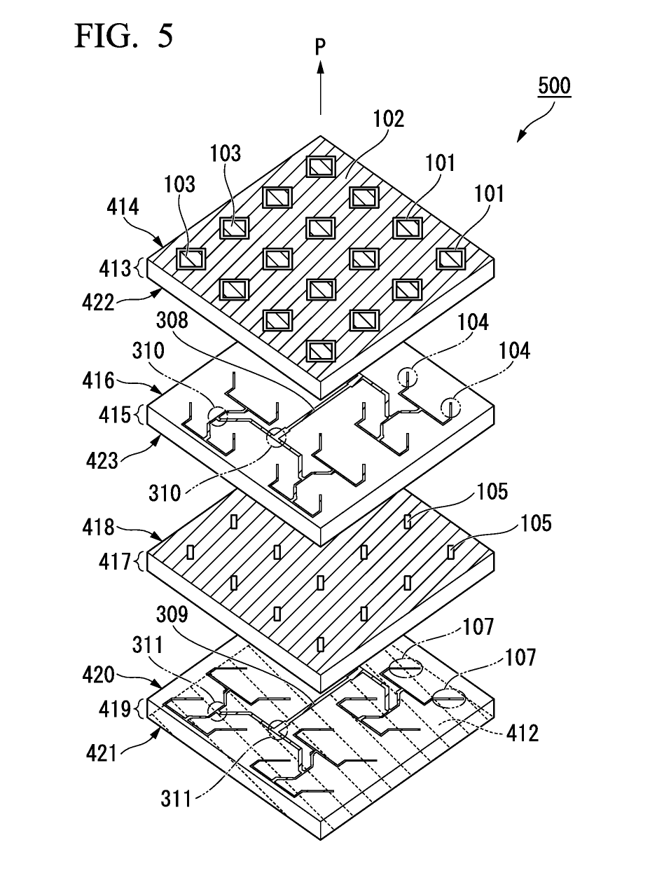

While the above-described second variation is arranged to include a third ground conductor 412 below the second feed probe 107 in the lamination direction P. As illustrated in FIG. 5, the dual-polarized antenna 500 according to the fourth variation includes the first ground conductor 102 in which multiple openings 101 are provided; multiple metal patches 103; multiple first feed probes 104; the second ground conductor 106 in which multiple slots 105 are provided; multiple second feed probes 107; a first feed circuit 308; a second feed circuit 309; and a third ground conductor 412. The dual-polarized antenna 500 according to the fourth variation is different from the dual-polarized antenna 300 according to the above-described second variation in that it includes the third ground conductor 412.

Below, while omitting or simplifying the explanations for the same portion as the dual-polarized antenna 300 according to the above described second variation, points which are different from the dual-polarized antenna 300 according to the above-described second variation are explained.

Conductor portions such as the first ground conductor 102 on which the opening 101 is provided, multiple metal patches 103, multiple first feed probes 104, a first feed circuit 308, the second ground conductor 106 in which multiple slots 105 are provided, multiple second feed probes 107, a second feed circuit 309, a third ground conductor 412, etc., are formed by a conductive material, etc., patterned on a surface of the dielectric substrate.

The first ground conductor 102 and multiple metal patches 103 are formed on a first main surface 414 of a first dielectric substrate 413. The multiple first feed probes 104 and the first feed circuit 308 are formed on a first main surface 416 of a second dielectric substrate 415. The second ground conductor 106 is formed on a first main surface 418 of a third dielectric substrate 417. The second feed probe 107 and the second feed circuit 309 are formed on a first main surface 420 of a fourth dielectric substrate 419. The third ground conductor 412 is formed on a second main surface 421 of the fourth dielectric substrate 419.

The second ground conductor 106 and the third ground conductor 412, and the second feed circuit 309 and multiple second feed probes 107 arranged between the second ground conductor 106 and the third ground conductor 412 form a stripline, or a triplate line.

In the fourth variation, the second ground conductor 106 and the third ground conductor 412 cover the second feed circuit 309 in both sides. The presence of the third ground conductor 412 suppresses the undesired radiation from radiation sources, for example, each of the second feed probes 107 and the T-type branch 311, wherein the undesired radiation is a radiation directed in the opposite direction to the direction of the main radiation of the metal patch 103.

Below, the fifth variation is described.

A dual-polarized antenna 600 according to the fifth variation may include multiple metal posts 624 which are arranged to surround the periphery of the opening 101.

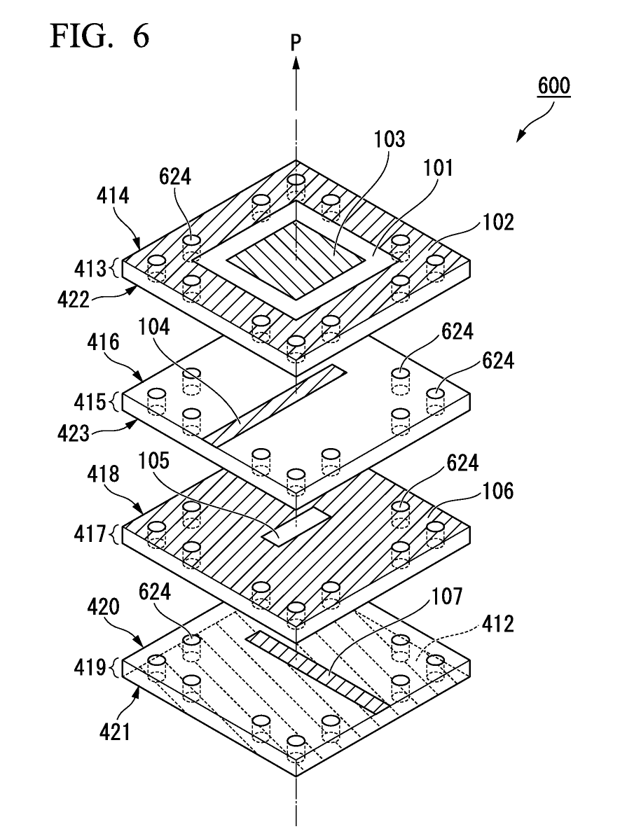

As shown in FIG. 6, the dual-polarized antenna 600 according to the fifth variation includes the first ground conductor 102 in which the opening 101 is provided; the metal patch 103; the first feed probe 104; the second ground conductor 106 in which the slot 105 is provided; the second feed probe 107; and multiple metal posts 624. The dual-polarized antenna 600 according to the fifth variation is different from the above-described dual-polarized antenna 400 according to the third variation in that it has multiple metal posts 624.

Below, while omitting or simplifying the explanations for the same portion as the dual-polarized antenna 400 according to the above described third variation, points which are different from the dual-polarized antenna 400 according to the above-described third variation are explained.

The first ground conductor 102 and the second ground conductor 106, and the first feed probe 104, which is arranged between the first ground conductor 102 and the second ground conductor 106, form a stripline, or a triplate line.

The second ground conductor 106 and the third ground conductor 412, and the second feed probe 107, which is arranged between the second ground conductor 106 and the third ground conductor 412, form a stripline, or a triplate line.

Multiple metal posts 624 are mounted in multiple through holes which penetrate each of the first dielectric substrate 413, the second dielectric substrate 415, the third dielectric substrate 417, and the fourth dielectric substrate 419. Multiple metal posts include sets of two metal posts 624 that are arranged along each side of a rectangular opening 101 and a metal post 624 which is arranged outside each apex of the rectangular opening 101. Each of the multiple metal posts 624 short-circuits between the first ground conductor 102 and the second ground conductor 106 and between the second ground conductor 106 and the third ground conductor 412.

The fifth variation, having the multiple metal posts 624, may suppress a parallel plate mode which occurs within the parallel plate waveguide which is formed in each of the first ground conductor 102 and the second ground conductor 106 and the second ground conductor 106 and the third ground conductor 412. The fifth variation, having the multiple metal posts 624 which suppress the parallel plate mode, may suppress decrease of radiation efficiency of the metal patch 103 and degradation of radiation directivity due to leakage from the end of the metal patch 103. Moreover, an array antenna which includes multiple metal patches 103 may suppress unwanted coupling between neighboring metal patches 103 and prevent degradation of the antenna characteristics. In the above-described fifth variation, the multiple metal posts 624 may provide each of the first dielectric substrate 413, the second dielectric substrate 415, the third dielectric substrate 417, and the fourth dielectric substrate 419 independently.

In the above-described fifth variation, the multiple metal posts 624 may be a through hole which integrally penetrates the first dielectric substrate 413, the second dielectric substrate 415, the third dielectric substrate 417, and the fourth dielectric substrate 419 in the lamination direction P.

In the above-described fifth variation, the multiple metal posts 624 may be a metal via in which each of the first dielectric substrate 413, the second dielectric substrate 415, the third dielectric substrate 417, and the fourth dielectric substrate 419 is stacked when fabricating in a buildup method.

Below, a sixth variation is described.

While it is described in the fifth variation that multiple metal posts 624 which are arranged to surround the periphery of the opening 101 are included, it is not limited thereto. In the above-described fifth variation, the metal post 624 which is arranged outside each of apexes of the rectangular opening 101 may be omitted.

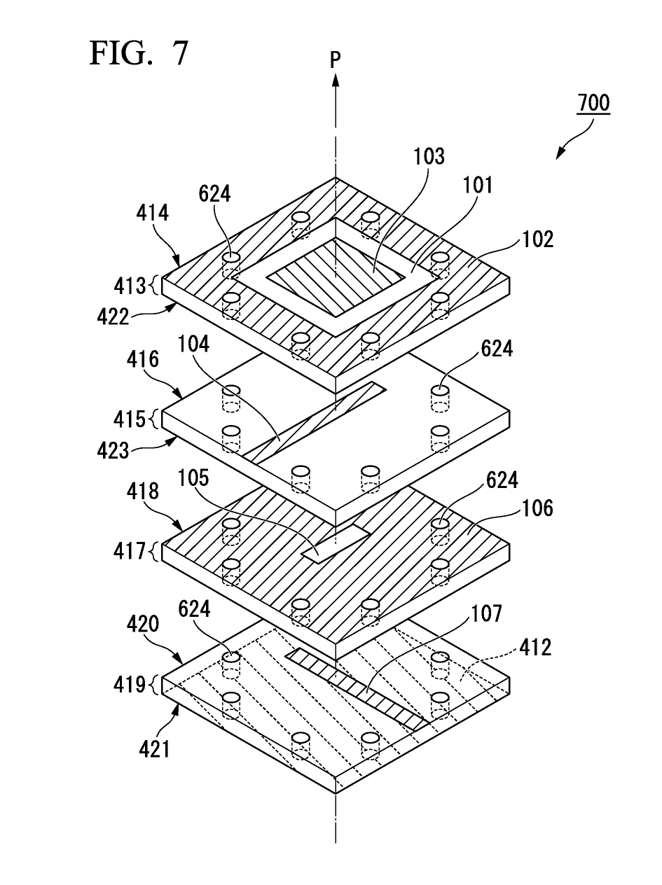

As shown in FIG. 7, the dual-polarized antenna 700 according to the sixth variation includes sets of two metal posts 624 which are arranged along each side of the rectangular opening 101.

According to the sixth variation, in the array antenna which includes multiple metal patches 103, a location for laying a feed circuit in the array antenna may be secured while suppressing unwanted coupling between neighboring metal patches 103. This makes it possible to increase the degree of freedom of the layout of the feed circuit.

Below, a seventh variation is described.

In the above-described embodiment, at least one of the first feed probe 104 and the second feed probe 107 may include a stub 825.

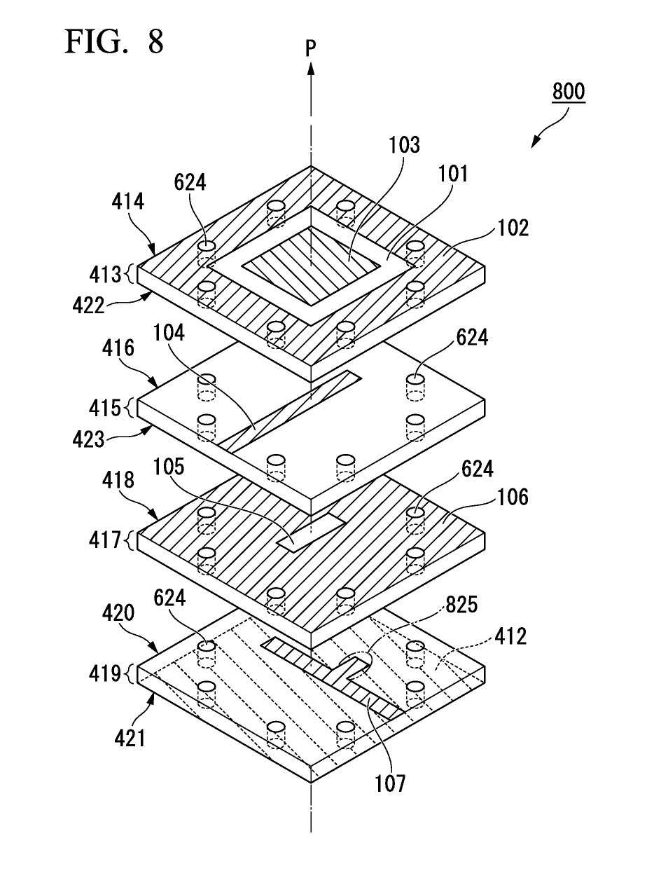

As shown in FIG. 8, a dual-polarized antenna 800 according to the seventh variation includes the first ground conductor 102 in which the opening 101 is provided, the metal patch 103, the first feed probe 104, the second ground conductor 106 in which the slot 105 is provided, the second feed probe 107, multiple metal posts 624, and a stub 825 which is provided in the second feed probe 107. The dual-polarized antenna 800 according to the seventh variation is different from the dual-polarized antenna 700 according to the above-described sixth embodiment in that it includes the stub 825.

Below, while omitting or simplifying the explanations for the same parts as the parts in the dual-polarized antenna 700 according to the above-described sixth variation, points thereof which are different from those of the above-described dual-polarized antenna 700 according to the above-described sixth variation are explained.

According to the seventh variation, even when a relative bandwidth in which the metal patch 103 operates is equal for each of the first polarized wave and the second polarized wave, multi-resonance, etc., by a stub 825 may increase the bandwidth of the lower frequency band of the second polarized wave, where the bandwidth of the lower frequency band is likely to be narrower than the bandwidth of the higher frequency band of the first polarized wave.

According to the seventh variation, a stub may be provided in the first feed probe 104 to increase the bandwidth of the higher frequency band of the first polarized wave.

Below, a different variation is explained.

While it is explained that conductor portions such as the first ground conductor 102 in which the opening 101 is provided, the metal patch 103, the first feed probe 104, the second ground conductor 106 in which the slot 105 is provided, and the second feed probe 107, etc., are formed by a conductive material, etc., patterned on a surface of an insulating material, it is not limited thereto.

An insulator which may be inserted between laminated metal plates may be provided with the first ground conductor 102 in which the opening 101 is provided, the metal patch 103, the first feed probe 104, the second ground conductor 106 in which the slot 105 is provided, and the second feed probe 107 as the metal plate.

While the dual-polarized antenna 100 is set to be a linear polarized shared antenna in the above-described embodiment, it is not limited thereto, so that it may be set to be a circular polarized shared antenna.

In other cases, degeneracy separation method may be used for the circularly polarized antenna, wherein the metal patches have modified asymmetrical shapes. For example, the antenna may include a pair of metal patches, each of which has a generally rectangle shape with at least one modified corner and remaining angled corners. A typical example of the modified corner may be, but is not limited to, a truncated corner.

The above-described embodiment, the first to seventh variations, and the different variation may be appropriately combined.

The above-described at least one embodiment, having a slot which provides matching at a frequency lower than the resonant frequency of the metal patch itself may cause the aspect ratio of the metal patch to be smaller than the frequency ratio of the first frequency to the second frequency.

Moreover, the first feed probe having the longitudinal direction which is generally parallel to the longitudinal direction of the slot and the second feed probe having the longitudinal direction which is generally parallel to the longitudinal direction of the slot make it possible to improve the cross polarization discrimination.

Furthermore, the first feed probe and the second feed probe whose mutual longitudinal directions are generally orthogonal make it possible to improve isolation between an input/output in which the first feed probe is connected and an input/output port in which the second feed probe is connected.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A dual-polarized antenna comprising:
a first ground conductor having an opening;
a metal patch as a radiation element positioned equal to or lower in level in a lamination direction than the first ground conductor, the metal patch being positioned in the opening of the first ground conductor in view of a direction vertical to a surface of the first ground conductor;
a first feed probe positioned under the first ground conductor in the lamination direction, the first feed probe that excites the metal patch;
a second ground conductor positioned below the first feed probe in the lamination direction, the second ground conductor having a slot which is generally parallel to the first feed probe, the slot being positioned under the metal patch in the lamination direction; and
a second feed probe disposed under the second ground conductor in the lamination direction, the second feed probe being generally perpendicular to the slot,
wherein the metal patch has an aspect ratio which is smaller than a frequency ratio of a first frequency to a second frequency where the second frequency is lower than the first frequency, the first frequency is of a first polarized wave that the metal patch receives and transmits upon power feed from the first feed probe, and the second frequency is of a second polarized wave that the metal patch receives and transmits upon power feed from the second feed probe through the slot.

2. The antenna as claimed in claim 1, further comprising:
a third ground conductor positioned below the second feed probe in the lamination direction.

3. The antenna as claimed in claim 1,
wherein the first feed probe and the second feed probe are positioned under the center of the metal patch in the lamination direction,
wherein the slots has the center which is positioned under the center of the metal patch in the lamination direction.

4. The antenna as claimed in claim 1, further comprising:
at least one metal post disposed at the periphery of the opening.

5. The antenna as claimed in claim 4,
wherein the opening has a shape of rectangle, and
wherein the at least one metal post comprises a plurality of metal posts which includes four pairs of metal posts, each pair of which is disposed along a respective one of the four sides of the periphery of the opening.

6. The antenna as claimed in claim 1, further comprising:
a stub extending from the second feed probe.

7. The antenna as claimed in claim 1, further comprising:
a stub extending from the first feed probe.

8. The antenna as claimed in claim 1, further comprising:
a plurality of sets each comprising the opening, the metal patch, the first feed probe, the slot, and the second feed probe,
a first feed circuit which connects the plurality of first feed probes; and
a second feed circuit which connects the plurality of second feed probes.

9. The dual-polarized antenna as claimed in claim 8,
wherein the number of the plurality of sets is given by 2^{N}×2^{N}, where N is the arbitrary natural number.

10. A dual-polarized antenna comprising:
a first ground conductor;
a metal patch;
a first feed probe coupled to the metal patch;
a second ground conductor disposed in an opposite side to the metal patch with reference to the first feed probe, the second ground conductor having at least one of an empty space and a non-empty space of insulator; and
a second feed probe spatially separated by the at least one of the empty space and the non-empty space of insulator from the first feed probe, the second feed probe being coupled to the metal patch through at least one of the empty space and the non-empty space of insulator.

11. The antenna as claimed in claim 10, wherein the first feed probe is configured to be electromagnetically coupled to the metal patch.

12. The antenna as claimed in claim 10, wherein the second feed probe is configured to be electromagnetically coupled through at least one of the empty space and the non-empty space of insulator to the metal patch.

13. The antenna as claimed in claim 10, wherein the first feed probe is back-coupled to the metal patch.

14. The antenna as claimed in claim 10, wherein the first ground conductor has at least one opening which is larger in size than the metal patch.

15. The antenna as claimed in claim 10, wherein the first ground conductor has at least one opening which is larger in size than the metal patch, and the metal patch is positioned in the at least one opening, and the metal patch is substantially the same in level as the first ground conductor.

16. The antenna as claimed in claim 10, wherein the empty space is a slot which is generally parallel in longitudinal direction to the first feed probe.

17. The antenna as claimed in claim 10, wherein the metal patch and at least one of the empty space and the non-empty space of insulator overlap each other at least in part from a view vertical to the surface of at least one of the first and second ground conductors.

18. The antenna as claimed in claim 10, wherein the first and second feed probes cross each other in an overlap area in which the metal patch and at least one of the empty space and the non-empty space of insulator overlap from a view vertical to the surface of at least one of the first and second ground conductors.

19. The antenna as claimed in claim 10,
wherein the metal patch and at least one of the empty space and the non-empty space of insulator overlap each other at least in part from a view vertical to the surface of at least one of the first and second ground conductors, and
wherein the first and second feed probes cross each other in an overlap area in which the metal patch and at least one of the empty space and the non-empty space of insulator overlap from the view.

20. The antenna as claimed in claim 10, wherein at least one of the empty space and the non-empty space of insulator has a dimension which allows an impedance matching between the metal patch and the second feed probe at a frequency lower than a resonant frequency of the metal patch.
